(19) United States
(12) Patent Application Publication
(10) Pub. No.: US 2001/0048454 A1
(43) Pub. Date: Dec. 6, 2001

(54) FLUID JET NOZZLE

(76) Inventors: DAVID WESTBERG, UPPSALA (SE); GERT ANDERSSON, LINDOME (SE)

Correspondence Address: MATTHEW E CONNORS, SAMUELS GAUTHIER STEVENS & REPPERT, 225 FRANKLIN STREET, SUITE 3300, BOSTON, MA, 02110

(21) Appl. No.: 09/092,500

(22) Filed: Jun. 5, 1998

(30) Foreign Application Priority Data
Jun. 6, 1997 (SE) 9702166-1

(51) Int. Cl. B41J 2/05; H05B 3/00; B21D 53/76

(52) U.S. Cl. 347/61; 347/62; 347/26; 29/611; 29/890.1; 29/DIG. 16; 216/27

(57) ABSTRACT

The present invention relates a method of manufacturing a monolithic thermal fluid jet nozzle for the electronically controlled propulsion of fluids characterized by the steps of arranging said nozzle on a substrate on which at least one dielectric layer and at least one layer of metal or metal strip have been deposited; removing at least part of the deposited metal layer, leaving chancels adjacent to said at least dielectric layer or in-between dielectric layers, for the transportation of fluids; applying at least one heating element to the channel for fluid propulsion, which element superheats the fluid to form a vapour bubble which ejects at least part of the surrounding fluid through the nozzle.

### TECHNICAL FIELD

The present invention relates to a method of manufacturing a monolithic thermal fluid jet nozzle for the electronically controlled propulsion of fluids.

The invention also relates to nozzles manufactured using the method according to the invention.

### PRIOR ART

Thermoelectric actuation is the dominating fluid propulsion mechanism used in miniature fluid jet nozzle heads on the market today. Such nuzzles are known, for example through: M. O'Horo, J. O'Neill, E. Peeters, S. Vandebroek. “Micro Electro Mechanical System Technology for Commercial Thermal Ink jet Document Output Products”, Proceedings Eurosensors X, pp. 431-435, Sep. 1996 and S. Aden, J. Bohdórquez, D. Collins, D. Crook, A. Garcia, U. Hess, “The Third-Generation HP Thermal Ink jet Printhead”, Hewlett-Packard Journal, vol. 45, pp. 41-45, Feb. 1994. A small volume of fluid is rapidly superheated forming a vapour bubble. The expansion of the bubble pressurizes the surrounding fluid causing a drop to be ejected from a nearby nozzle. The speed and volume of the drop depend on the geometry of the nozzle and the heating area as well as the characteristics of the applied heating. The described type of fluid jet nozzle heads is often referred to as a bubble jet.

Two types of bubble jets can de distinguished, the edgeshooter and the sideshooter, see for example; P. Krause, E. Obermeier, W. Wehl, “Backshooter—A New Smart Micromachined Single-chip Ink jet Printhead”, Transducers '95, Digest of Technical Papers, vol. 2, pp. 325-328, Jun. 1995. The edge-shooter is characterized by the fact that the ink drops leave the head normal to a cut or etched edge of the chip. The channels are typically anisotropically etched v-grooves in silicon substrates. A second wafer containing heaters, power transistors, and addressing logic for the different channels is aligned and glued or bonded on top of the wafer containing the v-grooves, thereby sealing the channels. A monolithic edge-shooter has been presented in J. Chen, K. Wise, “A High-Resolution Silicon Monolithic Nozzle Array for Ink jet Printing”, Transducers '95, Digest of Technical Papers, vol. 2, pp. 321-324, Jun. 1995. The channels are formed by undercutting chevron-shaped silicon ribs and then sealing the top with deposited dielectrics. The other type of bubble jet, the side-shooter, ejects the drops normal to the top surface of the chip. The nozzles are usually made by electroforming, which is described in D. Lee, H-D. Lee, H-J. Lee, J-B. Yoon, K-H. Han, J-K Kim, C-K Kim, C-H. Han, “A Monolithic Thermal Ink jet Printhead Utilizing Electrochemical Etching and Two-Step Electroplating Techniques”. International Electron Device Meeting, Technical Digest, vol. 1026, pp. 601-604, 1995 and R. Askeland, W. Childers, W. Sperry, “The Second-Generation Thermal Ink jet Structure”, Hewlett-Packard Journal, vol. 39, pp. 28-31, Aug. 1988.

Other known manufacturing methods are found in D. Westberg, O. Paul, H. Blaltes, “Surface Micromachining by Sacrificial Aluminium Etching”, Journal of Micromechanics and Microengineering, vol. 6, pp. 376-384, Dec. 1996; O. Paul, D. Westberg, M. Hornung, V. Ziebart, H. Baltes, “Sacrificial Aluminium Etching for CMOS Microstructures”, Proceedings MEMS'97, pp. 523-528, Jan. 1997 and D. Westberg, O. Paul, G. Andersson, H. Baltes, “A CMOS-Compatible Device for Fluid Density Measurements”, Proceedings MEMS'97, pp. 278-283, Jan. 1997.

The easiest way of fabricating a tube using sacrificial layer etching is to deposit metal onto a plane supporting material, whereby the metal is patterned and covered with a new layer. Finally, the metal is etched off to form the tube. This method works properly but there are some problems:

The height of the tube is defined by the thickness of the metal. Accordingly, to be able to produce high tubes a thick layer of metal must be deposited. When the metal thickness is, for example about 0, 5 Om the surface becomes clearly raw, which then becomes rougher and rougher with increasing thickness. The layer deposited above the metal assumes the same form as the metal. Consequently, the inner top of the tube becomes very rough which results in different problems depending on the application.

When high tubes are fabricated, steps at the metal edges become large and must be covered by the next layer. Usually, this will result in tubes with small deficiencies, so called pinholes, at the edge sections. This defect can be removed, e.g. by providing an unnecessary thick layer,

### SUMMARY OF THE INVENTION

The main object of this invention is to overcome above-mentioned problems in respect of manufacturing tubes in semiconductor applications, specially in inkjet applications and present a new, substantially filly integrated fabrication method, for example utilising sacrificial aluminium etching. Another object of the present invention is to present a manufacturing method where well defined tubes of dielectrics can easily be fabricated by first enclosing metal wires between dielectric layers and then removing the metal by wet etching. The manufacturing process according to the present invention is compatible with standard IC-fabrication techniques and it requires typically only two extra mask steps after completed CMOS, NMOS or PMOS processing.

Yet, another object of the present invention is to provide a new CMOS-, NMOS- or PMOS-compatible fabrication process for miniaturised monolithic thermal ink jet heads. The ink channels are formed by sacrificial removal of metal wires in a standard CMOS, NMOS or PMOS process. This simplifies the processing and enables close spacing of the channels. It also allows for easy integration of nozzle and electronics. A demonstrator fabricated using a commercially available CMOS process followed by straightforward postprocessing is presented as well as specially made CMOS compatible structures. Typical dimensions of the channels are about 10 μm wide, 0.5-1.5 μm thick, and 300-600 μm long.

Above objects arc achieved through a method characterised by the steps of arranging said nozzle on a substrate on which at least one dielectric layer and at least one layer of metal or metal strip have been deposited, removing at least part of the deposited metal layer, leaving channels adjacent to said at least one dielectric layer or in-between dielectric layers, for the transportation of fluids, applying at least one beating element to the channel for fluid propulsion, which element superheats the fluid to form a vapor bubble which ejects at least part of the surrounding fluid through the nozzle.

According to one preferred method according to the invention said at least one layer of metal or metal strip is patterned or printed. The metal consist of aluminum, tungsten, nickel, copper or any combination thereof. The substrate is made of silicon, III-V materials (i.e. compounds of column III and V in periodic table of elements). glass, quartz or any combination thereof. The dielectric layer is made of thermal silicon oxides (silicon monoxides, silicon dioxide), deposited silicon oxides, deposited silicon nitride, deposited silicon dioxide, plastics, polymers or any combination thereof.

The channel layout is preferably defined by metal strips or wires on a CMOS, NMOS or PMOS compatible or CMOS, NMOS or PMOS processed wafer, The metal strips or wires are exposed by forming e.g. a pad-like structure or cutting or grinding the substrate or part of it so as to prepare for the creation of an etch window. At least one active heater element is applied in close proximity to the channel, locally supplying heat to the channel. Said heater element is made of CMOS. NMOS or PMOS gate polysilicon.

In an advantageous method according to the invention said metal is removed by sacrificial metal etching. The method is also characterized by removing the substrate below the section of the channel containing the heating element so as to reduce the thermal losses to de substrate. The substrate may be removed through anisotropic etching.

At least one of the polysilicon heating elements is protected from aggressive fluids transported in the channel, by a layer of the same material used as a diffusion barrier in the metal to polysilicon contact in the CMOS, NMOS or PMOS process. The lateral profile of the nozzle is defined through dry etching. An outermost part of the nozzle is released from the substrate through bulk micromachining (EDP (ethylenediamine, pyrocatechol, pyrazin, and water solution), TMAH (tetramethyl ammoniumhydroxide and water solution) or KOH (potassium hydroxide)).

In an preferred embodiment the electronic circuits (power drivers and addressing logic) arc integrated on the same chip as the nozzles. Also an array of nozzles may be integrated on one chip an said array of nozzles may form a multi-dimensional nozzle array.

The invention also refers to a method of fabricating a tube for liquid medium supply in a semiconductor application, preferably a monolithic thermal fluid jet nozzle and a tube thereof. The method comprises the steps of; arranging a least a channel on a substrate, applying a first layer on the substrate, depositing a sacrificial metal, burnishing down said metal until substantially only the metal in the channel is remained, depositing a second layer over the metal, forming an upper part of the tube, and etching off the sacrificial metal to obtain the tube.

### SHORT DESCRIPTION OF THE FIGURES

In the following the, the invention will be described more detailed by reference to images, taken by means of a secondary electron microscope, showing some non limiting embodiments, in which:

FIGS. 1a-1h show schematically steps in a process for producing a device according to the invention.

FIGS. 2a-2h show schematically steps in another process for producing a device according to me invention.

FIG. 3 is a microscope image showing a profile of first embodiment of the nozzle, fabricated according to the present invention.

FIG. 4 is a microscope image of a second embodiment of nozzle fabricated according to the present invention.

FIG. 5 is a perspective view showing a cut through a nozzle during the fabrication process., according to the present invention.

FIG. 6 is an elevation view illustrating a mask layer.

FIG. 7 is a microscope image of the channel opening structure of yet another embodiment.

FIG. 8 is a microscope image of a close-up of a typical resulting nozzle according to the present invention.

FIG. 9 is a microscope image of the heater part of a nozzle according to the present invention.

FIG. 10 is a microscope image another embodiment of a heater part of a nozzle, according to the present invention.

### DESCRIPTION OF THE INVENTION

The invention relates to a thermally actuated miniature monolithic fluid jet nozzle and the production thereof. The nozzle substantially consists of a channel for ejecting the fluid and a heater for creating a vapour bubble that will propel the fluid through the channel.

To fabricate a nozzle and overcome above-mentioned problems, according to simplest way of carrying out the invention, it is possible to countersink the metal in the substrate to obtain a plane and almost level upper edge.

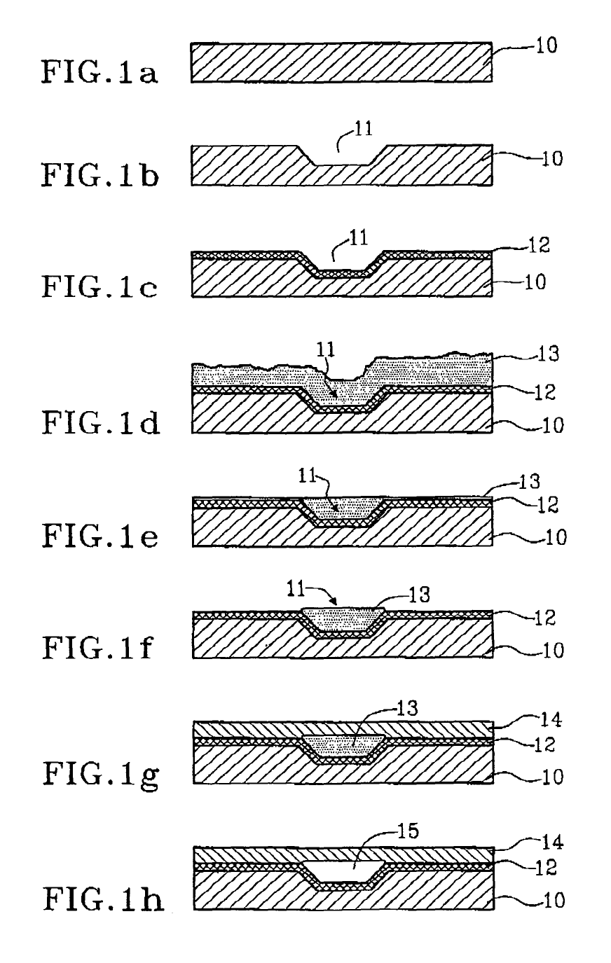

FIGS. 1a-1h show steps in a first process according to a method. Stag with a substrate 10, for example of some suitable material such as silicon or the like, channels 11 are etched into it. This may be carried out anisotropically, as shown, or isotropically. The etching may either be carried Out wet or dry. A layer 12 can be deposited or gown on the substrate 10. The layer 12 may be a thermal oxide, deposited oxide or deposited nitride- The sacrificial metal 13, such as for example aluminium, is deposited through sputtering, evaporation or plating in a sufficient amount to entirely cover the etched channel 11. Preferably, the metal is burnished down until substantially just the metal in the channel is remained, as shown in FIG. 1e. Presumably, the burnishing step is stopped just before reaching layer 12 and the remaining metal is etched off, FIG. 1f. Then a new layer 14, for example of same material as layer 12 or of other suitable material such as silicon nitride or other dielectrical, material is deposited over the metal 13, which forms the upper part of the tube. Finely, the sacrificial metal is etched off obtaining a very smooth and well-defined cavity or tube 15, whose upper edge is substantially entirely in same level as the rest of the supporting material 12.

In an ink jet application, in which a heating element must be implemented in the channel, the element could be provided either as diffused resistor in the substrate or as a deposited resistor under or in a lower dielectric layer, or on or inside a dielectric layer. The process may be carried out compatible with the conventional IC-processing, which makes it possible to integrate the corresponding electronics and the tubes.

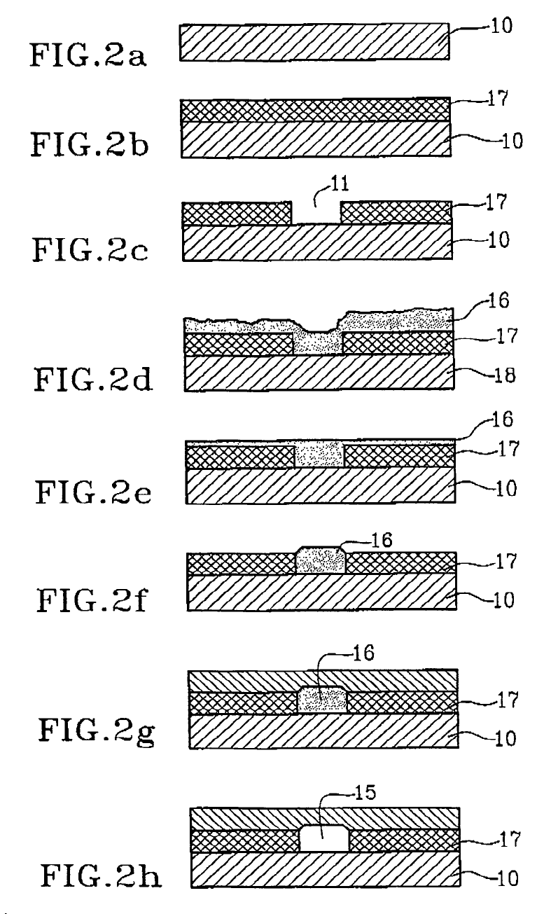

FIGS. 2a-2h illustrate same steps as in FIGS. 1a-1h and the same reference signs are used to denote same parts. However, in this case the metal 16 is countersunk in a deposited material 17 on top of the substrate.

Obviously, the method for producing the tube can be used in other applications to produce cavities, for example for supplying fluids or the like.

The jet nozzle is manufactured using a standard process for semiconductor fabrication (e.g. CMOS, NMOS or PMOS) combined with sacrificial metal etching. Consequently, standard semiconductor or semiconductor related materials can be used, e.g. silicon, III-V-materials, glass, quartz or a combination of these for the substrate. The dielectric layers are also of standard ceramic types, e.g. thermal or deposited silicon oxides (including silicon monoxide and silicon dioxide), nitrides or oxynitrides. Hence, the nozzle can preferably be fabricated on the same chip and in the same process as the electronics that can be used to control and drive it (e.g. power drivers (transistors) and addressing logic), which allows for miniaturisation and process efficiency.

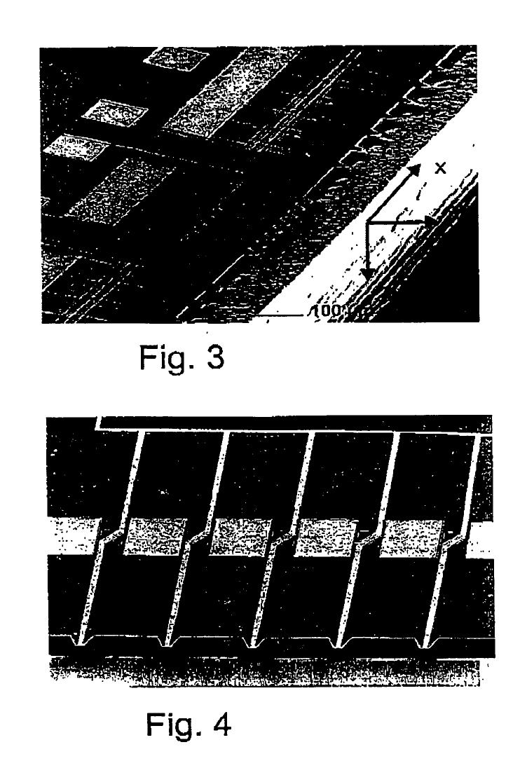

Starting from a substrate, a dielectric layer is added. Polysilicon or metal is deposited to form heaters. Metal wires (e.g. aluminium, tungsten, nickel or copper or a combination of these) are added in order to define the layout of the channels. Another dielectric layer is deposited. An etch window is created so that the metal wires become exposed. The channels are created using sacrificial metal etching, which removes the metal wires. Masking and dry-etching is used to locally remove the dielectric and hence to shape the lateral (i.e. XY-plane in FIG. 3) profile of the nozzle. Anisotropic bulk machining (e.g. EDP, TMAH or KOH) is used to release the nozzle tips from the substrate.

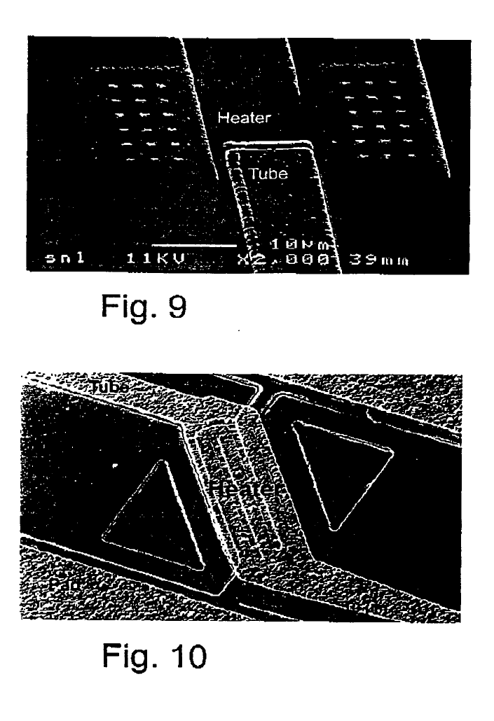

A typical heater in communication with tube is shown in FIG. 9. The volume above the heater is in the order of only about 50 μm³. The power needed (about 25 mW/heater) to generate bubbles is also large, which requires large driving transistors. The heaters of the in-house fabricated structures, shown in FIG. 10, therefore have a new shape allowing the tube in the heating area to be anisotropically undercut. This will substantially reduce the required heating power and the channel crosstalk.

Fabrication examples

Different types of processes can be used: the first one, hereinafter called Type I, the product of which is shown in FIG. 3 is based on a CMOS process. In the example, an approximately 0.8 μm CMOS process of Austria Mikro Systerne International (AMS) was used. The second one, hereinafter called Type II, the product of which is shown in FIG. 4 is fabricated in a CMOS-compatible wafer-scale process.

Type I—Post-processed CMOS-chips

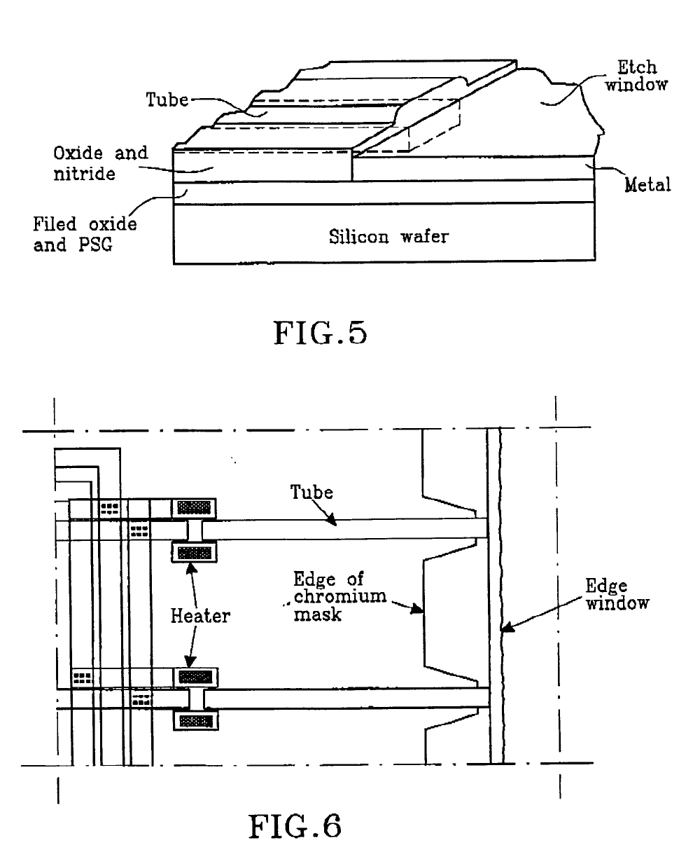

Already diced and CMOS-processed chips were obtained through a multi-project-wafering. By proper layout of metal wires, the interior dimensions of the channel are defined. In this example, aluminium is used. The etchant has to be adapted to the metal used. Using only one metal layer results in about 0.5 μm high structures. Using several metal layers, one placed on top of the other and integrated by a via, a metal thickness of typically 1.5 μm is achieved. At the nozzle end of the channel the metal lines are terminated in a pad-like structure later acting as an etch window for the sacrificial etching, see FIG. 5. The etch window can also be obtained through e.g. grinding or cutting the wafer so that the metal becomes exposed. Gate polysilicon is patterned and used as heaters. To increase the thermal conductivity between the heater and the liquid, a metal-to-polysilicon contact is made at the heater. The polysilicon is protected from the aggressive ink by a thin layer of titanium nitride used as diffusion barrier in the CMOS process.

The first postprocessing step is to define the exterior of the nozzle. This is done by anisotropic dry-etching of the dielectric layers. The total thickness to be etched is approximately 3.5 μm. Therefore chromium is used as mask material. The chromium is evaporated and patterned according to FIG. 6. The edge of the nozzle is retracted a few microns from etch window to make sure that the channel tip does not bend. Before dry-etching, the visible metal has to be removed in order to remove the oxide below it. Approximately 20 minutes of etching in commercial aluminium etch at about 50° C. is sufficient to remove the metal in the etch window and a few microns into the channel. The chip is then dry-etched until all of the dielectric is removed in the exposed areas and the underlying silicon becomes visible.

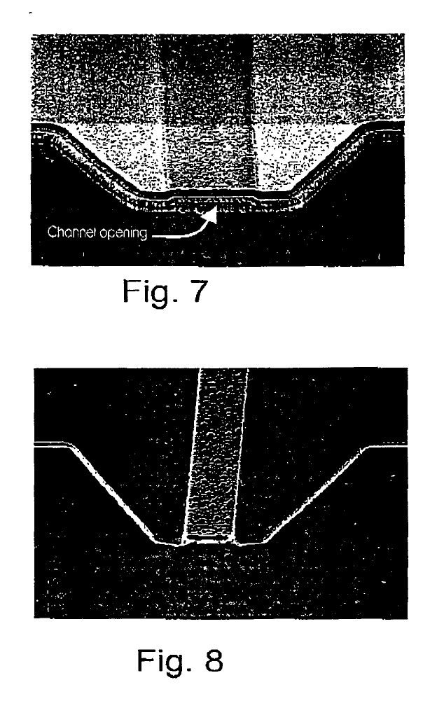

The following step is to release the outermost part of the nozzles by bulk micromachining using e.g. EDP or TMAH. The resulting structure is shown in FIGS. 7 and 8. The chromium used as mask for the dry-etching can also serve as protection of the pads in the EDP-etch. However, the required etch time, from about 30 to 60 minutes at approximately 95° C., is short enough for the aluminium pads to survive without protection.

The next step is to create the channels by extended sacrificial aluminium etching. Using a solution composed of four volumetric parts of HCl (37%), two parts of H₂O, and one part of H₂O (30%) at about 40° C. all of the metal in approximately 300 μm long channels is removed within about 30 minutes. Commercial aluminium etchant also works fine provided the wires only contain aluminium. However, it requires substantially longer processing time. The etching is diffusion limited and the required etch time increases as the square of the channel length. Finally, washing and dicing completes the fabrication. Care has to be taken not to break the nozzles with the water jet of the diamond saw. If photoresist is used to secure them, baking of the resist should be kept to a minimum to ensure that it can later, easily be removed and does not clog the channels.

Type II

The Type II test structures were fabricated on 3-inch wafers in a clean-room. The process is intended to be filly CMOS-compatible. First the wafers were thermally oxidised to a thickness of about 5000 Å. Polysilicon was then deposited and patterned to form the heaters and pads. A thin oxide was deposited and contact holes for the pads were made, before a thick layer (about 1.0-1.5 μm) of aluminium was evaporated. The aluminium was patterned defining the shape of the channels and than covered with a thick (approximately 1-1.5 μm) deposited oxide. The rest of the processing conforms closely to that of Type I. FIG. 3 shows a close-up of a typical resulting nozzle.

As the process is CMOS compatible, the electronics necessary to control the nozzles, e.g. drive transistors and addressing logic could be incorporated on the same substrate.

The invention is not limited die shown embodiments but can be varied in a number of ways without departing from the scope of the appended claims and the arrangement and the method can be implemented in various ways depending on application, functional units, needs and requirements etc.

1. A method of manufacturing a monolithic thermal fluid jet nozzle, preferably for electronically controlled propulsion of fluids wherein the method comprises the steps of:
arranging said nozzle on a substrate on which at least one dielectric layer and at least one layer of metal or metal strip have been deposited,
removing at least part of the deposited metal layer, leaving channels adjacent to said at least one dielectric layer or in-between dielectric layers, for the transportation of fluids,
applying at least one heating element to the channel for fluid propulsion, which element superheats the fluid to form a vapor bubble which ejects at least part of the surrounding fluid through the nozzle.

2. The method of claim 1, wherein said at least one layer of metal or metal strip is patterned or printed.

3. The method of claim 1, wherein the metal consist of aluminum, tungsten, nickel, copper or any combination thereof.

4. The method of claim 1, wherein the substrate is made of silicon, III-V materials, glass, quartz or any combination thereof.

5. The method of claim 1, wherein the dielectric layer is made of thermal silicon oxides (silicon monoxide, silicon dioxide), deposited silicon oxides, deposited silicon nitride, deposited silicon oxynitride, plastics, polymers or any combination thereof.

6. The method of claim 1, wherein the method further comprises defining the channel layout by metal strips or wires of a CMOS, NMOS or PMOS compatible or CMOS, NMOS or PMOS processed wafer.

7. The method of claim 1, wherein the metal strips or wires are exposed by forming a pad-like structure or cutting or grinding the substrate or part of it so as to prepare for the creation of an etch window.

8. The method of claim 1, wherein at least one active heater element is applied in close proximity to the channel, locally supplying heat to the channel.

9. The method of claim 8, wherein the heater element is made of CMOS, NMOS or PMOS gate polysilicon.

10. The method of claim 1, wherein said metal is removed by sacrificial metal etching.

11. The method of claim 1, wherein the substrate is removed below the section of the channel containing the heating element so as to reduce the thermal losses to the substrate.

12. The method of claim 1, wherein the substrate is removed through anisotropic etching.

13. The method of claim 1, wherein at least one of the polysilicon heating elements is protected from aggressive fluids transported in the channel, by a layer of the same material used as a diffusion barrier in the metal to silicon contact in the CMOS, NMOS or PMOS process.

14. The method of claim 1, wherein the lateral profile of the nozzle is defined through dry etching.

15. The method of claim 1, wherein an outermost part of the nozzle is released from the substrate through bulk micromachining (EDP: ethylenediamine, pyrocatcehol, pyrazin, and water solution).

16. The method of claim 1, wherein an outermost part of the nozzle is released from the substrate through TMAH (tetramethyl ammoniumhydroxide and water solution).

17. The method of claim 1, wherein an outermost part of the nozzle is released from the substrate through KOH (potassium hydroxide).

18. The method of claim 1, wherein electronic circuits are integrated on the same chip as the nozzles.

19. The method of claim 1, wherein an array of nozzles are arranged on one chip.

20. The method of claim 19, wherein said array of nozzles form a multi- dimensional nozzle array.

21. A method of fabricating a tube for liquid medium supply in a semiconductor application, preferably a monolithic thermal fluid jet nozzle, wherein the method comprises the steps oft
arranging a least a channel on a substrate,
applying a first layer on the substrate,
depositing a sacrificial metal,
burnishing down said metal until substantially only the metal in the channel is remained,
depositing a second layer over the metal, forming an upper part of the tube, and
etching off the sacrificial metal to obtain the tube.

22. The method according to claim 21, wherein the channel is etched on trio substrate.

23. The method according to claim 21, wherein the channel is countersunk in a deposited material on the substrate.

24. A tube for liquid medium supply in a semiconductor application, preferably a monolithic thermal fluid jet nozzle, comprising:
a substrate,
a supporting layer,
a channel etched into said substrate or countersunk in a deposited layer, and
a covering layer, which together with the supporting layer forms a tube.

25. A tube according to claim 24, wherein said substrate is silicon.

26. A tube according to claim 24, wherein said supporting layer is of a thermal oxide deposited oxide or nitride.

27. A monolithic thermal fluid jet nozzle, comprising a tube according to claim 24 and further including a heating clement arranged as diffused resistor in the substrate or as a deposited resistor under or in a lower dielectric layer, or on or inside a dielectric layer.

28. A monolithic thermal fluid jet nozzle for the electronically controlled propulsion of a fluid wherein said nozzle consists of.
a substrate, having deposited on it at least one dielectric layer and at least one layer of metal or metal strip,
at least one channel adjacent to said at least one dielectric layer for the transportation of fluid, said channel consisting of said deposited metal layer at least part of which is removed,
heater clement for propulsion of the fluid, said heater element being applied to the channel, for superbeating which forms a vapour bubble in said fluid to eject the at least part of the fluid through the nozzle.
